(19) United States
(12) Patent Application Publication
(10) Pub. No.: US 2006/0140696 A1
(43) Pub. Date: Jun. 29, 2006

(54) Curl-correcting device for image-forming apparatus

(75) Inventors: Junji Uehara, Inazawa-shi (JP); Tomitake Aratachi, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/300,467

(22) Filed: Dec. 15, 2005

(30) Foreign Application Priority Data
Dec. 28, 2004 (JP) 2004-381917

(51) Int. Cl. G03G 15/00

(52) U.S. Cl. 399/406

(57) ABSTRACT

A curl-correcting device includes a first curl-correcting section and a second curl-correcting section. The first curl-correcting section is disposed on a conveying path along which a recording medium is conveyed in a conveying direction. The first curl-correcting section corrects curl in a recording medium having a first thickness. The second curl-correcting section is disposed on the conveying path either upstream or downstream of the first curl-correcting section in the conveying direction. The second curl-correcting section corrects curl in a recording medium having a second thickness greater than the first thickness.

### CROSS REFERENCE TO RELATED APPLICATIONS

This application claims priority to Japanese Patent Application No. P2004-381917, filed on Dec. 28, 2004, the contents of which are hereby incorporated by reference into the present application.

### TECHNICAL FIELD

The present invention relates to a curl-correcting device for correcting curl in a recording medium, and an image-forming apparatus equipped with the curl-correcting device.

### BACKGROUND

Conventional laser printers and other image-forming apparatuses have been provided with curl-correcting devices for correcting curl in a recording medium (recording paper). The curl-correcting device is disposed on a conveying path along which the recording medium is conveyed, downstream of a fixing unit provided for fixing an image on the recording medium.

Curl-correcting devices well known in the art include a type of device for correcting only curl in normal paper, without correcting curl in thick paper, and a type of device for varying the amount of curl correction based on the type of the recording medium, such as that disclosed in U.S. Pat. No. 6,246,860 (corresponding to Japanese patent application publication No. 2000-247526).

More specifically, the former curl-correcting device described above includes a conveying path on which a correcting mechanism is provided for correcting curl in normal paper and a conveying path having no correcting mechanism, and a path switching mechanism for guiding the recording medium to one of the two paths. The path switching mechanism is controlled based on the type of the recording medium selected by the user.

The latter curl-correcting device includes a large roller, two small rollers placed in contact with the large roller and having a smaller diameter than a diameter of the large roller, and a controller for moving the small rollers relative to the large roller. The recording medium is conveyed along a minor arc on the circumference of the large roller between a contact point at which the large roller contacts one of the small rollers and a contact point at which the large roller contacts the other of the small rollers.

In this curl-correcting device, the small rollers are moved relative to the large roller based on the type of the recording medium selected by the user, thereby modifying the distance between the large roller and the small rollers in order to vary the amount of curl correction.

### SUMMARY

However, since the former curl-correcting device has two conveying paths, the path switching mechanism is required. Consequently, the structure of the device is necessarily larger, and a control system is required for controlling the path switching mechanism based on the type of the recording medium.

Further, while the latter curl-correcting device does not require a path switching mechanism, a mechanism is required for moving the small rollers relative to the large roller in order to vary the amount of curl correction based on the type of the recording medium. Consequently, the structure of the device is also necessarily larger, and a control system is required for moving the small rollers based on the type of the recording medium.

In view of the foregoing, it is an object of the present invention to provide a curl-correcting device capable of correcting curl in a recording medium with a simplified structure.

In order to attain the above and other objects, according to one aspect, the present invention provides a curl-correcting device. The curl-correcting device includes a first curl-correcting section and a second curl-correcting section. The first curl-correcting section is disposed on a conveying path along which a recording medium is conveyed in a conveying direction. The first curl-correcting section corrects curl in a recording medium having a first thickness. The second curl-correcting section is disposed on the conveying path either upstream or downstream of the first curl-correcting section in the conveying direction. The second curl-correcting section corrects curl in a recording medium having a second thickness greater than the first thickness.

According to another aspect, the present invention provides an image-forming apparatus. The image-forming apparatus includes an image-forming unit, a fixing unit, a conveying unit, and a curl-correcting device. The image-forming unit forms an image on a recording medium by depositing toner thereon. The fixing unit fixes the image on the recording medium by fusing the toner. The conveying unit conveys the recording medium to the image-forming unit and to the fixing unit along a conveying path. The curl-correcting device is disposed downstream of the fixing unit on the conveying path. The curl-correcting device includes a first curl-correcting section and a second curl-correcting section. The first curl-correcting section is disposed on the conveying path along which a recording medium is conveyed in a conveying direction. The first curl-correcting section corrects curl in a recording medium having a first thickness. The second curl-correcting section is disposed on the conveying path either upstream or downstream of the first curl-correcting section in the conveying direction. The second curl-correcting section corrects curl in a recording medium having a second thickness greater than the first thickness.

### BRIEF DESCRIPTION OF THE DRAWINGS

The above and other objects, features and advantages of the invention will become more apparent from reading the following description of the embodiments taken in connection with the accompanying drawings in which:

FIG. 1 is a vertical cross-sectional view of a laser printer according to a first embodiment of the present invention;

FIG. 2A is a schematic drawing illustrating a curl-correcting section according to the first embodiment;

FIG. 2B is an explanatory diagram illustrating a curvature of a curved portion in a thick paper curl-correcting section;

FIG. 3A is an explanatory diagram illustrating operations of the curl-correcting section according to the first embodiment, when a recording paper is a thick paper;

FIG. 3B is an explanatory diagram illustrating operations of the curl-correcting section according to the first embodiment, when a recording paper is a normal paper;

FIG. 4 is a vertical cross-sectional view of a laser printer according to a second embodiment of the present invention;

FIG. 5 is a schematic drawing illustrating a curl-correcting section according to the second embodiment; and

FIG. 6 is a vertical cross-sectional view of a laser printer according to a third embodiment of the present invention.

### DETAILED DESCRIPTION OF THE EMBODIMENTS

A curl-correcting device and an image-forming apparatus according to embodiments of the present invention will be described while referring to the accompanying drawings.

<Overall Structure of a Laser Printer>

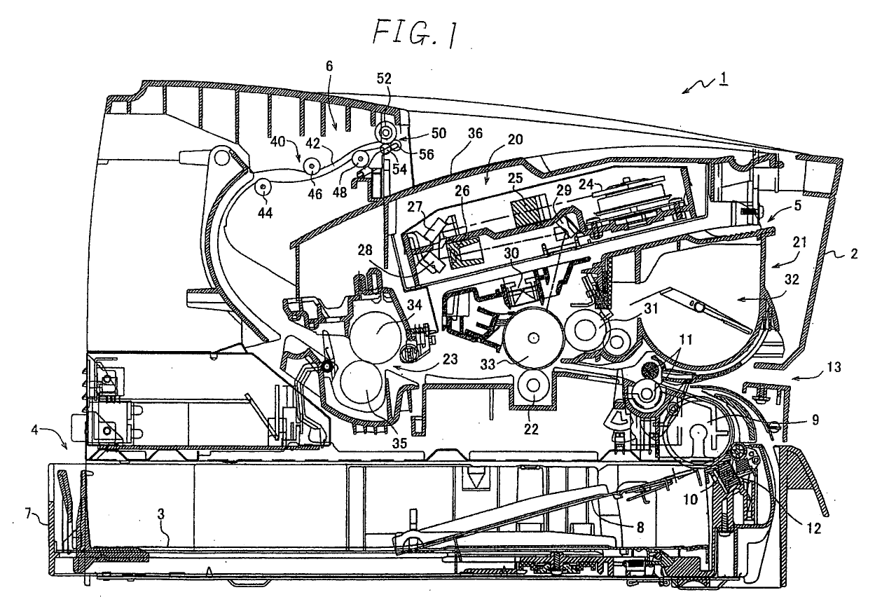

FIG. 1 is a vertical cross-sectional view of a laser printer 1 according to a first embodiment of the present invention. In the following description, the right side of the laser printer 1 shown in FIG. 1 will be referred to as the front side, and the left side as the rear side.

As shown in FIG. 1, the laser printer 1 includes a main casing 2 and, within the main casing 2, a feeding unit 4 for feeding sheets of a paper 3, an image-forming unit 5 for forming prescribed images on the paper 3 supplied from the feeding unit 4, a curl-correcting section 6 for correcting curl in the paper 3, and the like.

The feeding unit 4 is disposed in a bottom section of the main casing 2 and includes a paper tray 7 detachably mounted in the feeding unit 4, a paper-pressing plate 8 disposed in the paper tray 7, a feeding roller 9 and a separating pad 10 disposed above one end of the paper tray 7, and a pair of registration rollers 11 disposed downstream of the feeding roller 9 with respect to the direction in which the paper 3 is conveyed.

The paper 3 can be stacked on the paper-pressing plate 8. The paper-pressing plate 8 is pivotably supported on the end farthest from the feeding roller 9, enabling the end nearest the feeding roller 9 to move vertically. A spring (not shown) is disposed on the underside of the paper-pressing plate 8, urging the paper-pressing plate 8 upward. As the number of sheets of paper 3 stacked on the paper-pressing plate 8 increases, the paper-pressing plate 8 opposes the urging force of the spring and pivots downward about the support point on the end farthest from the feeding roller 9.

The feeding roller 9 and separating pad 10 are disposed in confrontation with each other. A spring 12 disposed on the underside of the separating pad 10 presses the separating pad 10 against the feeding roller 9. The topmost sheet of paper 3 stacked on the paper-pressing plate 8 is pressed against the feeding roller 9 by the spring disposed on the underside of the paper-pressing plate 8. The rotation of the feeding roller 9 interposes the topmost sheet of paper 3 between the feeding roller 9 and separating pad 10. Subsequently, through the cooperative operation of the separating pad 10, the feeding roller 9 feeds the paper 3 to the registration rollers 11 one sheet at a time.

After adjusting the paper 3 to a prescribed register position, the registration rollers 11 convey the paper 3 to the image-forming unit 5.

The feeding unit 4 further includes a manual feed slot 13. The manual feed slot 13 is formed in the front side of the main casing 2 at a vertical position substantially equivalent to the registration rollers 11. Paper 3 that is inserted by the user into the manual feed slot 13 is guided to the registration rollers 11.

The image-forming unit 5 includes a scanning unit 20, a process cartridge 21, a transfer roller 22, and a fixing unit 23.

The scanning unit 20 is disposed in an upper section of the main casing 2 and includes a laser light-emitting unit (not shown), a polygon mirror 24 that can be driven to rotate, lenses 25 and 26, and reflecting mirrors 27, 28, and 29. A laser beam emitted from the laser light-emitting unit based on prescribed image data passes through or is reflected by the polygon mirror 24, lens 25, reflecting mirror 27 and reflecting mirror 28, lens 26, and reflecting mirror 29 in sequence, as indicated by the dotted line in the drawing, and is irradiated in a high-speed scan across the surface of a photosensitive drum 33 in the process cartridge 21 described later.

The process cartridge 21 is disposed below the scanning unit 20 and is detachably mounted in the main casing 2. The process cartridge 21 is provided with a Scorotron charger 30, a developing roller 31, a toner-accommodating section 32, the photosensitive drum 33, and the like.

The toner-accommodating section 32 is filled with a positively charged, non-magnetic, single-component polymerized toner. This toner is carried on the surface of the developing roller 31 as a thin layer having a uniform thickness.

The photosensitive drum 33 is provided so as to be capable of rotating in confrontation with the developing roller 31. The photosensitive drum 33 is configured of a main drum body that is grounded, and a surface that includes a positively charged photosensitive layer formed of polycarbonate or the like.

As the photosensitive drum 33 rotates, the charger 30 charges the surface of the photosensitive drum 33 with a uniform positive polarity. Subsequently, the scanning unit 20 irradiates a laser beam in a high-speed scan to form an electrostatic latent image on the surface of the photosensitive drum 33 based on prescribed image data. Next, positively charged toner carried on the surface of the developing roller 31 comes into contact with the photosensitive drum 33 as the developing roller 31 rotates and is supplied to areas on the surface of the positively charged photosensitive drum 33 that were exposed to the laser beam and, therefore, have a lower potential. In this way, the latent image on the photosensitive drum 33 is developed into a visible image according to a reverse development process.

The transfer roller 22 is rotatably supported on the main casing 2 in confrontation with the photosensitive drum 33 on the lower side thereof. The transfer roller 22 is configured of a metal roller shaft covered by a roller that is formed of an electrically conductive rubber material. A prescribed transfer bias is applied to the photosensitive drum 33 during a transfer operation. As a consequence, the visible toner image carried on the surface of the photosensitive drum 33 is transferred onto a sheet of paper 3 passing between the photosensitive drum 33 and transfer roller 22. After the visible image is transferred, the paper 3 is conveyed to the fixing unit 23.

The fixing unit 23 is disposed downstream of the process cartridge 21 in the paper-conveying direction. The fixing unit 23 includes a heating roller 34, and a pressure roller 35. The heating roller 34 includes a metal tube, and a halogen lamp disposed within the tube to function as a heater. The pressure roller 35 is disposed below and in opposition to the heating roller 34 and contacts the heating roller 34 with pressure. The pressure roller 35 is configured of a metal roller shaft covered with a roller that is formed of a heat-resistant rubber material.

In the fixing unit 23, toner transferred onto the paper 3 in the process cartridge 21 is fused and fixed to the paper 3 by heat as the paper 3 passes between the heating roller 34 and pressure roller 35. After the fixing process, the paper 3 is conveyed to the curl-correcting section 6.

When passing through the fixing unit 23, the paper 3 tends to curl toward the surface on which the image is fixed. Specifically, since the pressure roller 35 presses against the heating roller 34 as the paper 3 passes through the fixing unit 23, the paper 3 passes along the circumference of the heating roller 34 and tends to curl in a concave shape on the image fixing surface.

<Structure of the Curl-Correcting Section 6>

The curl-correcting section 6 includes a thick paper curl-correcting section 40 for correcting curl in thick paper, and a normal paper curl-correcting section 50 for correcting curl in normal paper. The thick paper curl-correcting section 40 is disposed upstream of the normal paper curl-correcting section 50 with respect to the paper-conveying direction. After curl is corrected in the curl-correcting section 6, the paper 3 is discharged onto a discharge tray 36 formed on the top of the main casing 2.

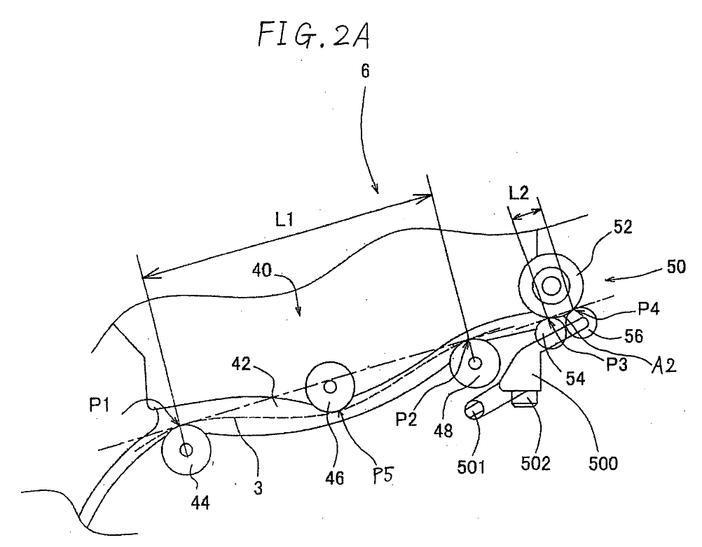

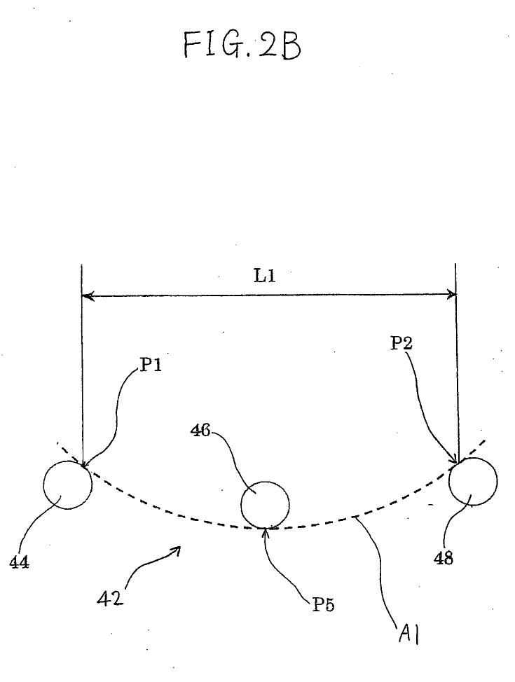

Next, the thick paper curl-correcting section 40 and normal paper curl-correcting section 50 will be described in greater detail with reference to FIGS. 2A and 2B. FIG. 2A is a schematic drawing of the curl-correcting section 6. FIG. 2B is an explanatory diagram illustrating a curvature of a curved portion 42 in the thick paper curl-correcting section 40. As shown in FIG. 2A, the thick paper curl-correcting section 40 includes the curved portion 42 that forms a curve in the conveying path of the paper 3 along the paper conveying direction; and conveying rollers 44, 46, and 48 for guiding the paper 3 conveyed to the curved portion 42 in the conveying direction.

The curved portion 42 is curved so as to sag downward in the center. The conveying roller 44 is disposed on the lower side of the curved portion 42 (the side facing the feeding unit 4) near the upstream end where the paper 3 enters the curved portion 42. The conveying roller 46 is disposed on the upper side of the curved portion 42 in the center portion thereof. The conveying roller 48 is disposed on the lower side of the curved portion 42 near the downstream end where the paper 3 exits the curved portion 42.

The paper 3 is conveyed along the curved portion 42 with the image surface facing downward. Consequently, the thick paper curl-correcting section 40 can correct curl in the paper 3 produced by the fixing unit 23 by bending the paper 3 in the opposite direction from the curl. After passing through the thick paper curl-correcting section 40, the paper 3 is conveyed to the normal paper curl-correcting section 50.

The normal paper curl-correcting section 50 includes a large roller 52 formed of an elastic material such as rubber, and two small rollers 54 and 56 formed of a stiff material such as synthetic resin and having a smaller diameter than the large roller 52. A motor (not shown) is provided for driving the large roller 52 to rotate. The small rollers 54 and 56 are rotatably supported on a support member 500. The support member 500 is pivotally supported about a shaft 501. An urging member 502 such as a spring applies an urging force to the support member 500 so that the small rollers 54 and 56 contact the large roller 52 with pressure and rotate along with the rotation of the large roller 52. With this construction, the small rollers 54 and 56 are movable toward and away from the large roller 52.

After passing through the thick paper curl-correcting section 40, the paper 3 passes between a contact point P3 between the large roller 52 and the small roller 54 and another contact point P4 between the large roller 52 and small roller 56 along the circumferential surface of the large roller 52. While the two contact points P3 and P4 are connected by two arcs following the circumferential surface of the large roller 52, the paper 3 is conveyed along the shorter arc (minor arc).

With this construction, the normal paper curl-correcting section 50 bends the paper 3 in a direction opposite the curl generated by the fixing unit 23 in order to correct this curl. After passing through the normal paper curl-correcting section 50, the paper 3 is discharged onto the discharge tray 36.

In the present embodiment, the minor arc of the large roller 52 is shorter than the curved portion 42 and has a curvature greater than a curvature of the curved portion 42. Note that a curvature is a reciprocal of a radius of curvature. Hence, a greater curvature indicates a smaller radius of curvature, and a smaller curvature indicates a greater radius of curvature. When the paper 3 is conveyed through the thick paper curl-correcting section 40, as indicated by the dotted line in FIG. 2A, the paper 3 is contacted by the conveying roller 44 and conveying roller 48 in the curved portion 42 at contact points P1 and P2 at upstream and downstream ends of the curved portion 42 in the paper-conveying direction. The paper 3 is also contacted by the conveying roller 46 at a contact point P5 between the contact point P1 and the contact point P2. As shown in FIG. 2B, the curvature of the curved portion 42 is defined as a curvature of an arc A1 determined by the three contact points P1, P5, and P2. Similarly, when the paper 3 is conveyed through the normal paper curl-correcting section 50, the paper 3 is contacted by the small rollers 54 and 56 at contact points P3 and P4 at upstream and downstream ends of the normal paper curl-correcting section 50 in the paper-conveying direction. The curvature of the normal paper curl-correcting section 50 is defined as a curvature of the minor arc A2 connecting contact points P3 and P4, that is, a curvature of the circumference of the large roller 52. The arc A1 of the curved portion 42 has a curvature smaller than a curvature of the minor arc A2 of the large roller 52. In other words, the thick paper curl-correcting section 40 has a curvature smaller than a curvature of the normal paper curl-correcting section 50. Further, a length L1 of a straight line connecting contact points P1 and P2 (indicated by a single-dot chain line in FIG. 2A) is designed to be greater than a length L2 of a straight line connecting contact points P3 and P4 (also indicated by a single-dot chain line in FIG. 2A). The paper 3 does not necessarily need to be conveyed along the arc A1, but the paper 3 passing through the thick paper curl-correcting section 40 needs to be conveyed along a path having a curvature smaller than the curvature of the paper 3 passing through the normal paper curl-correcting section 50.

Note that thicknesses of “normal paper” and “thick paper” differ depending on design specifications of the laser printer 1. The thick paper curl-correcting section 40 and the normal paper curl-correcting section 50 may be designed to have appropriate curvatures and lengths depending on the thickness of the normal paper and thick paper used in the laser printer 1.

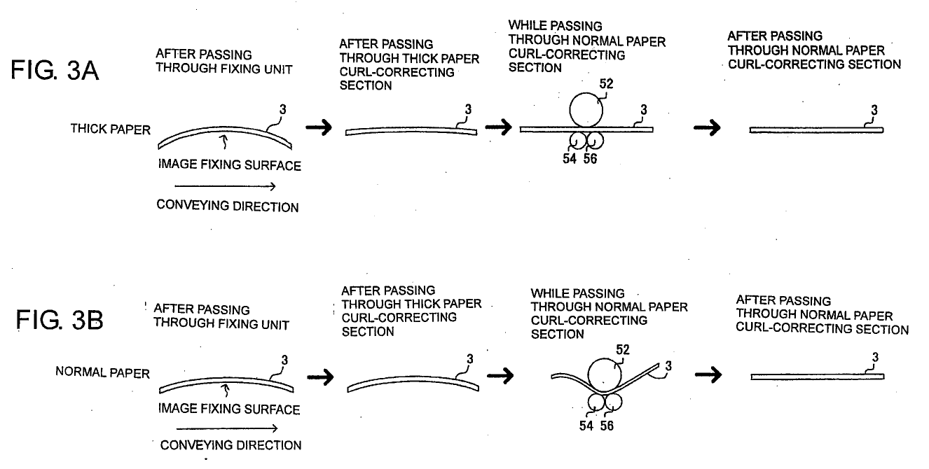

Next, the operations of the curl-correcting section 6 will be described with reference to FIGS. 3A and 3B. FIGS. 3A and 3B are explanatory diagrams illustrating the operations of the curl-correcting section 6. FIG. 3A is an explanatory diagram illustrating operations of the curl-correcting section 6 when the paper 3 is a thick paper, and FIG. 3B is an explanatory diagram illustrating operations of the curl-correcting section 6 when the paper 3 is a normal paper.

As shown in FIGS. 3A and 3B, a curl along the conveying direction toward the image surface side is produced in the paper 3 when the paper 3 passes through the fixing unit 23. Since the thick paper is stiffer than the normal paper, a larger amount of curl is generated in the thick paper.

As shown in FIG. 3A, curl in the thick paper can be corrected when the thick paper passes through the thick paper curl-correcting section 40. The thick paper is conveyed through the normal paper curl-correcting section 50 without being affected much by the curl correction performed by the normal paper curl-correcting section 50.

More specifically, since the thick paper is stiffer (i.e., has a greater flexural rigidity) than normal paper, curl in the paper can be corrected by conveying the paper through a curve that is longer and gentler than the normal paper curl-correcting section 50, that is, the curved portion 42. However, in the normal paper curl-correcting section 50, the thick paper presses against the small rollers 54 and 56, separating the small rollers 54 and 56 from the large roller 52. Accordingly, the normal paper curl-correcting section 50 has little effect on correcting curl in the thick paper. Consequently, the thick paper can be conveyed to the discharge tray 36 without being over-corrected.

As shown in FIG. 3B, normal paper is conveyed through the thick paper curl-correcting section 40 without being much affected by the thick paper curl-correcting section 40. Subsequently, curl in the normal paper is corrected when the paper passes through the normal paper curl-correcting section 50.

More specifically, since the normal paper is more yielding (i.e., has a smaller flexural rigidity) than the thick paper, curl in the normal paper is not corrected much by passing through the curved portion 42, but is corrected by passing along the minor arc A2 of the large roller 52 while receiving pressure from the small rollers 54 and 56.

In the laser printer 1 having the construction described above, the thick paper curl-correcting section 40 and normal paper curl-correcting section 50 are disposed along the same path. Hence, the curl in both thick paper and normal paper can be corrected with a single conveying path.

Further, since the thick paper curl-correcting section 40 and normal paper curl-correcting section 50 operate as separate mechanisms, the curl-correcting section 6 need not be provided with a control system for switching curl correction modes based on the type of the paper 3.

Hence, the laser printer 1 according to the first embodiment need not be provided with a plurality of conveying paths nor a mechanism for switching paths. Since a control system for switching correction modes is unnecessary, the structure of the device can be simplified.

Further, the thick paper curl-correcting section 40 can correct only curl in thick paper, without correcting curl in normal paper, while the normal paper curl-correcting section 50 can correct only curl in normal paper, without correcting curl in thick paper. Therefore, the correction of the curl-correcting section 6 avoids over-correction of curl in the paper 3.

Further, since the thick paper curl-correcting section 40 includes the conveying rollers 44, 46, and 48, the paper 3 can be conveyed smoothly, thereby reducing friction on the paper 3.

Further, the thick paper curl-correcting section 40 is disposed nearer the fixing unit 23 than the normal paper curl-correcting section 50 to improve the effect of curl correction on thick paper.

Accordingly, the laser printer 1 can correct curl in thick paper while the paper 3 is still heated from the image-fixing operation.

In the normal paper curl-correcting section 50 according to the first embodiment, the large roller 52 is fixed, while the small rollers 54 and 56 are urged toward the large roller 52 by the support member 500 and the urging member 502. However, the small rollers 54 and 56 may be fixed, while the large roller 52 is urged toward the small rollers 54 and 56. Alternatively, the small rollers 54 and 56 may be configured of an elastic material such as rubber and may be held so as to contact the large roller 52 with pressure.

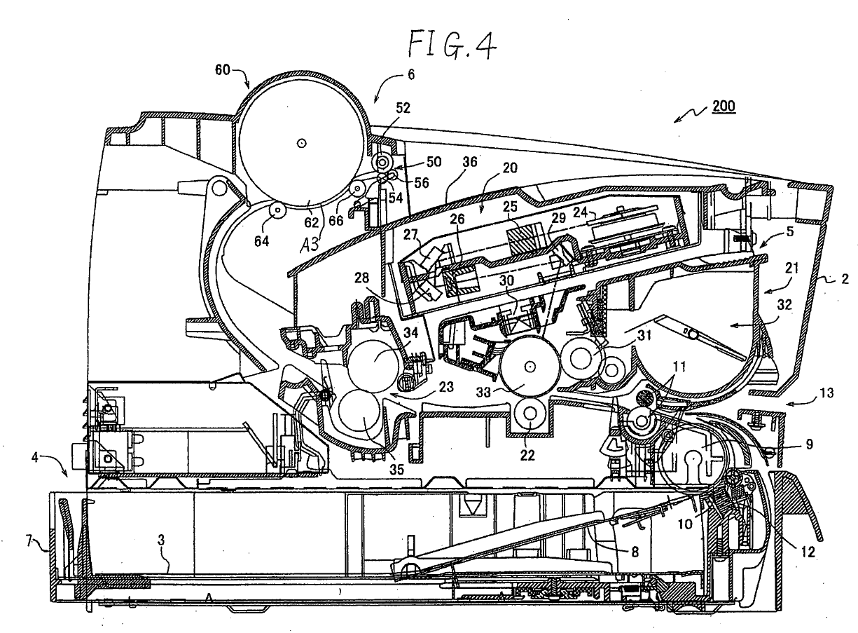

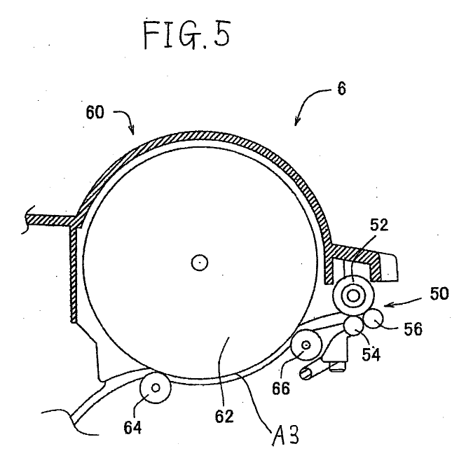

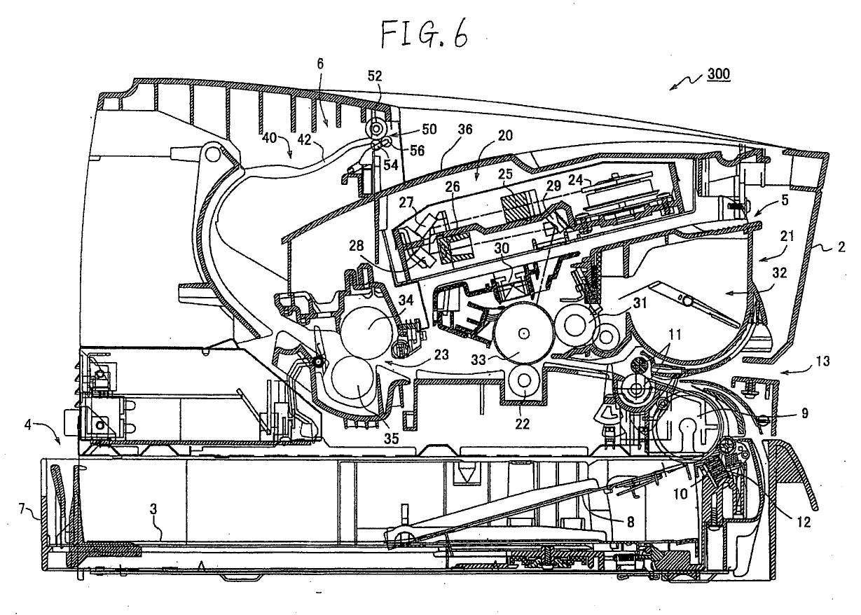

Next, a laser printer 200 according to a second embodiment of the present invention will be described with reference to FIGS. 4 and 5. FIG. 4 is a vertical cross-sectional view of the laser printer 200 according to the second embodiment. FIG. 5 is a schematic drawing showing the structure of the curl-correcting section 6 according to the second embodiment. In FIGS. 4 and 5, like parts and components to the laser printer 1 according to the first embodiment are designated with the same reference numerals to avoid duplicating description. The same holds for the third embodiment described later.

The laser printer 200 according to the second embodiment differs from the laser printer 1 according to the first embodiment in that a thick paper curl-correcting section 60 is provided in place of the thick paper curl-correcting section 40.

Specifically, the thick paper curl-correcting section 60 includes a large roller 62 that is driven to rotate by a motor (not shown), and two small rollers 64 and 66 that have a smaller diameter than the large roller 62 and contact the large roller 62 with pressure. The small rollers 64 and 66 follow the rotation of the large roller 62.

The paper 3 is conveyed to the thick paper curl-correcting section 60 after passing through the fixing unit 23. In the thick paper curl-correcting section 60, the paper 3 passes between a contact point between the large roller 62 and small roller 64 and a contact point between the large roller 62 and small roller 66 along the circumferential surface of the large roller 62. As in the first embodiment, the paper 3 is conveyed along a minor arc A3 between the two contact points, which is the shorter of the two arcs that follow the circumferential surface of the large roller 62 between the two contact points.

Consequently, the thick paper curl-correcting section 60 bends the paper 3 in an opposite direction from the curl produced in the fixing unit 23 in order to correct this curl. After passing through the thick paper curl-correcting section 60, the paper 3 is conveyed to the normal paper curl-correcting section 50.

In the second embodiment, as shown in FIG. 5, the curvature of the minor arc A3 along the large roller 62 is smaller than the curvature of the minor arc A2 (FIG. 2A) along the large roller 52. In other words, the diameter of the large roller 62 is larger than the diameter of the large roller 52 in the normal paper curl-correcting section 50. Further, the minor arc A3 of the large roller 62 is longer than the minor arc A2 of the large roller 52.

The laser printer 200 according to the second embodiment described above can obtain the same effects as the laser printer 1 according to the first embodiment. However, while the paper 3 always follows the same conveying path in the thick paper curl-correcting section 60 of the second embodiment, the paper 3 does not always follow the same conveying path in the curved portion 42 of the thick paper curl-correcting section 40 of the first embodiment.

Therefore, the laser printer 200 according to the second embodiment can perform more reliable curl correction of thick paper than the laser printer 1 according to the first embodiment. However, the laser printer 200 according to the second embodiment needs to be provided with a motor for rotating the large roller 62. Hence, the first embodiment is more advantageous for simplifying the device.

Next, a laser printer 300 according to a third embodiment of the present invention will be described with reference to FIG. 6. FIG. 6 is a vertical cross-sectional view of the laser printer 300 according to the third embodiment.

As shown in FIG. 6, the laser printer 300 according to the third embodiment differs from the laser printer 1 according to the first embodiment in that the thick paper curl-correcting section 40 does not include the conveying rollers 44, 46, and 48.

The laser printer 300 according to the third embodiment can obtain the same effects as the first and second embodiments described above.

Further, since the laser printer 300 does not include the conveying rollers 44, 46, and 48, the laser printer 300 is more advantageous than the laser printer 1 according to the first embodiment and the laser printer 200 according to the second embodiment for simplifying the device structure. However, the laser printer 1 according to the first embodiment and the laser printer 200 according to the second embodiment are advantageous in conveying performance of the paper 3.

While the invention has been described in detail with reference to the specific embodiment thereof, it would be apparent to those skilled in the art that various changes and modifications may be made therein without departing from the spirit of the invention.

For example, in the above-described embodiments, while the laser printers 1, 200, and 300 are each provided with the curl-correcting section 6, the image-forming apparatus of the present invention is not limited to this configuration. For example, the curl-correcting section 6 may be provided in a sorter designed to sort and rearrange the paper 3 into a specific page order. In this case, the laser printers 1, 200, and 300 need not include the curl-correcting section 6.

Further, the large roller 52 and small rollers 54 and 56 of the normal paper curl-correcting section 50 may be arranged in any configuration that has the rollers pressing against one another while the conveyed paper 3 is interposed therebetween. For example, the large roller 52 may be configured of an elastic member, while the small rollers 54 and 56 are configured of rigid members. When the large roller 52 and small rollers 54 and 56 are configured of rigid members, urging members such as springs may be provided on the small rollers 54 and 56 for urging the small rollers 54 and 56 toward the center axis of the large roller 52 to apply an urging force against the large roller 52.

While the embodiments describe the paper 3 using the examples of normal paper and thick paper, the present invention is not limited to these types of recording mediums. The same effects can be achieved when using a special recording medium, such as transparency sheets.

Further, since thick paper is stiffer than normal paper, the thick paper is preferably inserted through the manual feed slot 13. However, thick paper may also be stacked in the paper tray 7 and conveyed therefrom.

While the embodiments described above compare the thick paper curl-correcting section 40 or 60 to the normal paper curl-correcting section 50 in terms of curvature, these sections may be compared in other ways. For example, it is possible to find a ratio for a length of a straight line connecting the paper entrance and exit points of the curl-correcting sections 40, 50, and 60 along the paper-conveying path and a length of the longest normal to this straight line extending from the conveying path of the respective curl-correcting section, and to compare the curl-correcting sections 40, 50, and 60 based on these ratios.

Specifically, based on the example of FIG. 2A, the ratio for the thick paper curl-correcting section 40 is the ratio of the length L1 for the straight line connecting points P1 and P2 to the length of a normal to the straight line connecting points P1 and P2 from the contact point P5 at which the paper 3 contacts the conveying roller 46. The ratio for the normal paper curl-correcting section 50 is the ratio of the length L2 for the straight line connecting points P3 and P4 to the length of the longest normal to this straight line connecting points P3 and P4 and extending from the minor arc A2.

In the above-described embodiments, rollers contacting the large roller 52 or 62 are described as small rollers 54, 56, 64, and 66. However, the present invention is not limited to this large and small relationship. For example, the small rollers 54 and 56 may be configured with a larger diameter than the diameter of the large roller 52. Similarly, the small rollers 64 and 66 may be configured with a larger diameter than the diameter of the large roller 62.

What is claimed is:

1. A curl-correcting device comprising:
a first curl-correcting section disposed on a conveying path along which a recording medium is conveyed in a conveying direction, the first curl-correcting section correcting curl in a recording medium having a first thickness; and
a second curl-correcting section disposed on the conveying path either upstream or downstream of the first curl-correcting section in the conveying direction, the second curl-correcting section correcting curl in a recording medium having a second thickness greater than the first thickness.

2. The curl-correcting device according to claim 1, wherein the first curl-correcting section having a first curvature; and
wherein the second curl-correcting section having a second curvature smaller than the first curvature.

3. The curl-correcting device according to claim 1, wherein the first curl-correcting section comprises:
a first roller disposed on the conveying path and capable of rotating about an axis orthogonal to the conveying direction; and
two second rollers disposed on the conveying path and capable of rotating in a direction opposite a rotating direction of the first roller while contacting the first roller with an urging force, one of the two second rollers being in contact with the first roller at a first contact point, the other one of the two second rollers being in contact with the first roller at a second contact point, allowing the recording medium to be conveyed along a minor arc on a circumference of the first roller between the first contact point and the second contact point.

4. The curl-correcting device according to claim 3, wherein the second curl-correcting section comprises a curved portion that forms a curve in the conveying path; and
wherein the first and second curl-correcting sections satisfy a relationship L1>L2, where L1 is a length of a straight line between a third contact point at which the recording medium contacts the curved portion on an upstream end in the conveying direction and a fourth contact point at which the recording medium contacts the curved portion on a downstream end in the conveying direction, and L2 is a length of a straight line between the first contact point and the second contact point.

5. The curl-correcting device according to claim 4, wherein the second curl-correcting section comprises at least one conveying roller that guides a recording medium in the conveying direction.

6. The curl-correcting device according to claim 5, wherein the at least one conveying roller comprise three conveying rollers arranged along the curved portion;
wherein, a recording medium is conveyed in the second curl-correcting section, the recording medium contacts the three conveying rollers at three points, respectively; and
wherein an arc determined by the three points has a curvature smaller than a curvature of the minor arc of the first roller.

7. The curl-correcting device according to claim 3, wherein the second curl-correcting section comprises a curved portion that forms a curve in the conveying path;
wherein the curved portion has a length along the conveying path greater than a length of the minor arc of the first roller; and
wherein the curved portion has a curvature smaller than a curvature of the minor arc of the first roller.

8. The curl-correcting device according to claim 3, wherein the first curl-correcting section further comprises:
a support member that rotatably supports the two second rollers, the support member being pivotally supported about a shaft, allowing the two second rollers to be movable toward and away from the first roller; and
an urging member that applies the urging force to the support member so that the two second rollers contact the first roller with pressure.

9. The curl-correcting device according to claim 3, wherein the second curl-correcting section comprises:
a third roller disposed on the conveying path and capable of rotating about an axis orthogonal to the conveying direction, the third roller having a diameter greater than a diameter of the first roller; and
two fourth rollers disposed on the conveying path and capable of rotating in a direction opposite a rotating direction of the third roller while in contact with the third roller, one of the two fourth rollers being in contact with the third roller at a fifth contact point, the other one of the two fourth rollers being in contact with the third roller at a sixth contact point, allowing the recording medium to be conveyed along a minor arc on a circumference of the third roller between the fifth contact point and the sixth contact point; and
wherein the minor arc of the third roller is longer than the minor arc of the first roller.

10. An image-forming apparatus comprising:
an image-forming unit that forms an image on a recording medium by depositing toner thereon;
a fixing unit that fixes the image on the recording medium by fusing the toner;
a conveying unit that conveys the recording medium to the image-forming unit and to the fixing unit along a conveying path; and
a curl-correcting device disposed downstream of the fixing unit on the conveying path, the curl-correcting device comprising:
a first curl-correcting section disposed on the conveying path along which a recording medium is conveyed in a conveying direction, the first curl-correcting section correcting curl in a recording medium having a first thickness; and
a second curl-correcting section disposed on the conveying path either upstream or downstream of the first curl-correcting section in the conveying direction, the second curl-correcting section correcting curl in a recording medium having a second thickness greater than the first thickness.

11. The image-forming apparatus according to claim 10, wherein the second curl-correcting section is located closer to the fixing unit than the first curl-correcting section is.
